(19) United States
(12) Patent Application Publication
(10) Pub. No.: US 2026/0014762 A1
(43) Pub. Date: Jan. 15, 2026

(54) REPAIRING COMPOSITE THERMOPLASTIC COMPONENT USING INDUCTION / CONDUCTIVE HEATING

(71) Applicant: Rohr, Inc., Chula Vista, CA (US)

(72) Inventors: Shyan Bob Shen, San Diego, CA (US); Michael van Tooren, San Diego, CA (US); Milan Mitrovic, Del Mar, CA (US); Alfred Y. Tang, Riverside, CA (US)

(21) Appl. No.: 18/769,058

(22) Filed: Jul. 10, 2024

(51) Int. Cl. B29C 73/10; B29C 73/34

(52) U.S. Cl. CPC B29C 73/10; B29C 73/34

(57) ABSTRACT

A repair method is provided during which a thermoplastic structure is arranged on a support. A thermoplastic patch is arranged on the thermoplastic structure. A conductor is arranged on the thermoplastic patch with the thermoplastic patch between the conductor and the thermoplastic structure. The conductor is heated using an induction coil to provide a heated conductor. The thermoplastic patch is heated using the heated conductor to bond the thermoplastic patch to the thermoplastic structure.

### BACKGROUND

### 1. Technical Field

This disclosure relates generally to a repair method and, more particularly, to a method for repairing a composite thermoplastic component, also referred to as a thermoplastic composite component.

### 2. Background Information

Various methods are known in the art for repairing a composite thermoplastic aircraft component. While these known repair methods have various benefits, there is still room in the art for improvement.

### SUMMARY OF THE DISCLOSURE

According to an aspect of the present disclosure, a repair method is provided during which a thermoplastic structure is arranged on a support. A thermoplastic patch is arranged on the thermoplastic structure. A conductor is arranged on the thermoplastic patch with the thermoplastic patch between the conductor and the thermoplastic structure. The conductor is heated using an induction coil to provide a heated conductor. The thermoplastic patch is heated using the heated conductor to bond the thermoplastic patch to the thermoplastic structure.

According to another aspect of the present disclosure, another repair method is provided during which a thermoplastic patch is arranged on a thermoplastic structure. The thermoplastic structure includes a damaged area. The thermoplastic patch covers the damaged area. A metal conductor is arranged on the thermoplastic patch with the thermoplastic patch between the metal conductor and the thermoplastic structure. The metal conductor is heated using a heating element to provide a heated conductor. The thermoplastic patch is heated using the heated conductor to bond the thermoplastic patch to the thermoplastic structure and provide a repaired thermoplastic structure. The metal conductor is removed from the repaired thermoplastic structure.

According to still another aspect of the present disclosure, another repair method is provided during which a damaged area is removed from a damaged thermoplastic structure to provide a thermoplastic structure with an aperture. The aperture projects into the thermoplastic structure from an exterior surface of the thermoplastic structure. A thermoplastic patch is arranged on the thermoplastic structure with the thermoplastic patch at least partially filling the aperture. A metal conductor is arranged on the thermoplastic patch with the thermoplastic patch between the metal conductor and the thermoplastic structure. The metal conductor is heated using a heating element to provide a heated conductor. The thermoplastic patch is heated using the heated conductor to bond the thermoplastic patch to the thermoplastic structure and provide a repaired thermoplastic structure. The metal conductor is removed from the repaired thermoplastic structure.

The damaged area may be encapsulated by the thermoplastic patch in the repaired thermoplastic structure.

The repair method may also include arranging the thermoplastic structure on a support prior to arranging the thermoplastic patch on the thermoplastic structure.

The repair method may also include biasing the metal conductor towards the thermoplastic patch.

The thermoplastic structure may include thermoplastic material and fiber-reinforcement embedded within the thermoplastic material.

The thermoplastic patch may include thermoplastic material and fiber-reinforcement embedded within the thermoplastic material.

The thermoplastic structure may include second thermoplastic material and second fiber-reinforcement embedded within the second thermoplastic material. The thermoplastic material and the second thermoplastic material may be or otherwise include a common thermoplastic material.

The thermoplastic patch may be or otherwise include a pre-consolidated thermoplastic patch.

The thermoplastic patch may contact the thermoplastic structure. The thermoplastic patch may also or alternatively contact the conductor.

The conductor may be configured as or otherwise include a metal plate.

The thermoplastic patch may be bonded to the thermoplastic structure to provide a repaired thermoplastic structure. The repair method may also include removing the conductor from the repaired thermoplastic structure.

The induction coil may be configured as or otherwise include a linear induction coil.

The induction coil may be configured as or otherwise include a planar induction coil.

The repair method may also include biasing the conductor towards the support to press the thermoplastic patch between the conductor and the thermoplastic structure.

The conductor may be biased towards the support using a vacuum bag.

The thermoplastic structure may be configured as or otherwise include a damaged area. The thermoplastic patch may cover the damaged area. The thermoplastic patch may be bonded to the thermoplastic structure to provide a repaired thermoplastic structure.

The repair method may also include removing a damaged area from a damaged thermoplastic structure to provide the thermoplastic structure. The thermoplastic structure may include an aperture formed during the removing of the damaged area. The thermoplastic patch arranged on the thermoplastic structure may be disposed in and at least partially fills the aperture.

At least a portion of a peripheral geometry of the thermoplastic patch may be polygonal.

At least a portion of a peripheral geometry of the thermoplastic patch may be curved.

The present disclosure may include any one or more of the individual features disclosed above and/or below alone or in any combination thereof.

The foregoing features and the operation of the invention will become more apparent in light of the following description and the accompanying drawings.

### BRIEF DESCRIPTION OF THE DRAWINGS

FIG. 1 is a schematic illustration of an aircraft.

FIG. 2 is a partial schematic illustration of a repaired aircraft component.

FIG. 3 is a flow diagram of a method for repairing a composite thermoplastic component such as a damaged aircraft component.

FIGS. 4A-G are partial schematic illustrations depicting a sequence of steps for repairing a damaged aircraft component.

FIG. 5 is a partial plan view illustration of a linear induction coil.

FIG. 6 is a partial plan view illustration of a planar induction coil.

FIG. 7 is a schematic plan view illustration of a repaired aircraft component.

FIG. 8 is a schematic sectional illustration of the repaired aircraft component of FIG. 7.

FIGS. 9A-C are schematic illustrations depicting another sequence of steps for repairing a damaged aircraft component.

FIG. 10 is a schematic sectional illustration of a repaired aircraft component.

FIGS. 11 and 12 are plan view schematic illustrations of a patch with various geometries.

### DETAILED DESCRIPTION

The present disclosure includes methods for remanufacturing, fixing and/or otherwise repairing a thermoplastic component such as a composite thermoplastic component (also referred to as a “thermoplastic composite component”) of an aircraft. These repair methods may be utilized to restore one or more features of the aircraft component to usable condition, brand new condition, similar to brand new condition, better than brand new condition, etc.

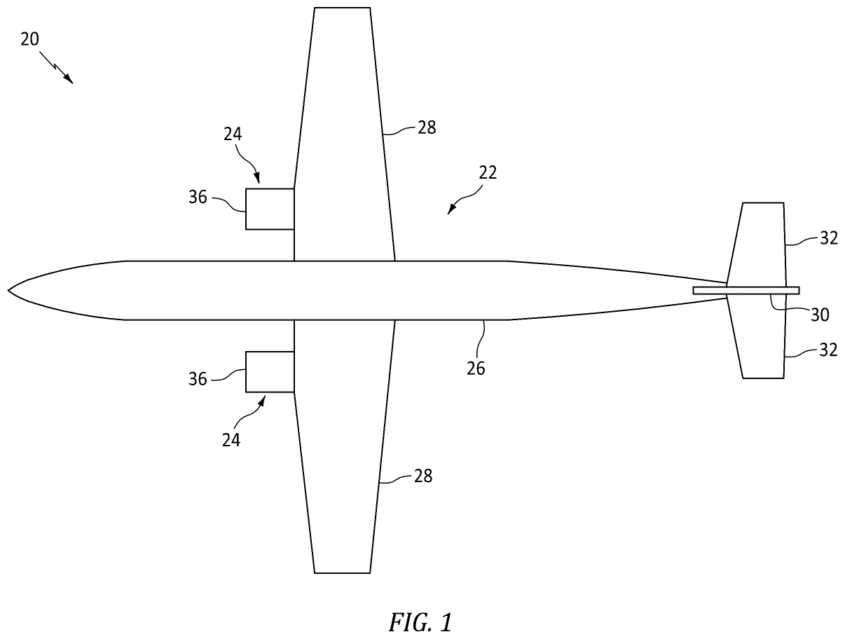

The aircraft may be an airplane, a helicopter, a drone (e.g., an unmanned aerial vehicle (UAV)), a missile, a rocket, or any other manned or unmanned aerial or aerospace vehicle or system. However, for ease of description, the aircraft may be generally described below as an airplane. An exemplary embodiment of such an aircraft 20 is shown in FIG. 1. This aircraft 20 includes an airframe 22 and one or more propulsion systems 24. The aircraft airframe 22 of FIG. 1 includes a fuselage 26, one or more wings 28, and one or more stabilizers 30 and 32. Each aircraft propulsion system 24 may include a power unit partially or completely housed within a nacelle 36. Examples of the power unit include, but are not limited to, a turbofan engine, a turboprop engine, a turbojet engine, a turboshaft engine, a rotary engine (e.g., a Wankel engine), a reciprocating piston engine, a hybrid powerplant and an electric motor.

The repair methods of the present disclosure may be used to repair various aircraft components. Such an aircraft component, for example, may be configured as or otherwise included as part of the aircraft fuselage 26, one of the aircraft wings 28, the vertical aircraft stabilizer 30, one of the horizontal aircraft stabilizers 32, the propulsion system nacelle 36, or any other composite thermoplastic member of the aircraft 20.

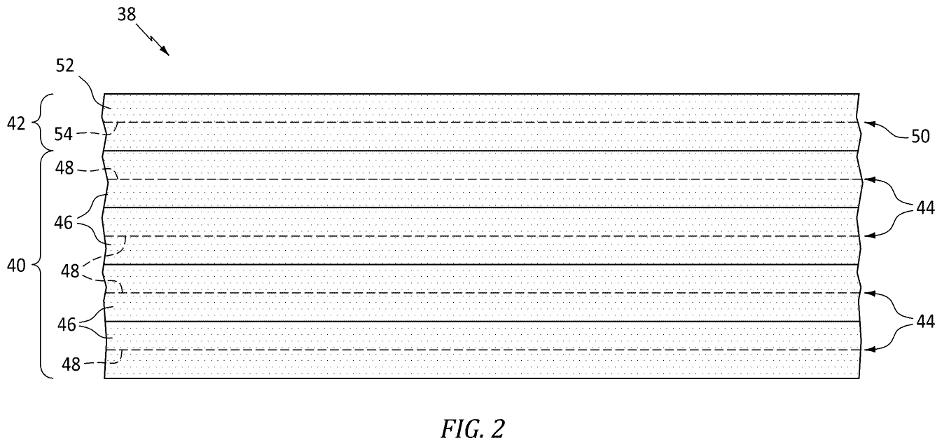

FIG. 2 schematically illustrates a repaired aircraft component 38-the aircraft component following performance of the repair thereon. This repaired aircraft component 38 includes a composite thermoplastic structure 40 and a composite thermoplastic patch 42 bonded (e.g., directly) to the thermoplastic structure 40.

The thermoplastic structure 40 may be formed from one or more consolidated layers 44 of composite thermoplastic material. Each thermoplastic composite structure (TCS) layer 44, for example, includes a thermoplastic matrix 46 and fiber reinforcement 48 embedded within the thermoplastic matrix 46. The thermoplastic matrix 46 is a thermoplastic material (e.g., a thermoplastic resin) such as, but not limited to, thermoplastic film polyamide (PA), polyamide-imide (PAI), polyarylsulfone (PAS), polyethersulfone (PES), polyoxymethylene (POM), polyphenylene sulfide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). The fiber reinforcement 48 may be or otherwise include fiberglass fibers, carbon fiber fibers, aramid (e.g., Kevlar®) fibers and/or the like. This fiber reinforcement 48 may be arranged as a (e.g., unidirectional, woven or unwoven) sheet of fibers and/or chopped fibers. The present disclosure, however, is not limited to such exemplary materials nor such a layered construction.

The thermoplastic patch 42 may be formed from one or more consolidated layers 50 of composite thermoplastic material (one shown for ease of illustration). Each thermoplastic composite structure (TCS) layer 50, for example, includes a thermoplastic matrix 52 and fiber reinforcement 54 embedded within the thermoplastic matrix 52. The thermoplastic matrix 52 is a thermoplastic material (e.g., a thermoplastic resin) such as, but not limited to, thermoplastic film polyamide (PA), polyamide-imide (PAI), polyarylsulfone (PAS), polyethersulfone (PES), polyoxymethylene (POM), polyphenylene sulfide (PPS), polyether ether ketone (PEEK), polyetherimide (PEI), polyethylene terephthalate (PET), polyphthalamide (PPA), poly ether ketone ketone (PEKK), or poly aryl ether ketone (PAEK). This thermoplastic matrix 52/thermoplastic material of the thermoplastic patch 42 may be the same as (or different than, but bondable with) the thermoplastic matrix 46/thermoplastic material of the thermoplastic structure 40. The fiber reinforcement 54 may be or otherwise include fiberglass fibers, carbon fiber fibers, aramid (e.g., Kevlar®) fibers and/or the like. This fiber reinforcement 54 may be arranged as a (e.g., unidirectional, woven or unwoven) sheet of fibers and/or chopped fibers. The present disclosure, however, is not limited to such exemplary materials nor such a layered construction. The thermoplastic patch 42, for example, may alternatively be configured without the fiber reinforcement 54 in select embodiments.

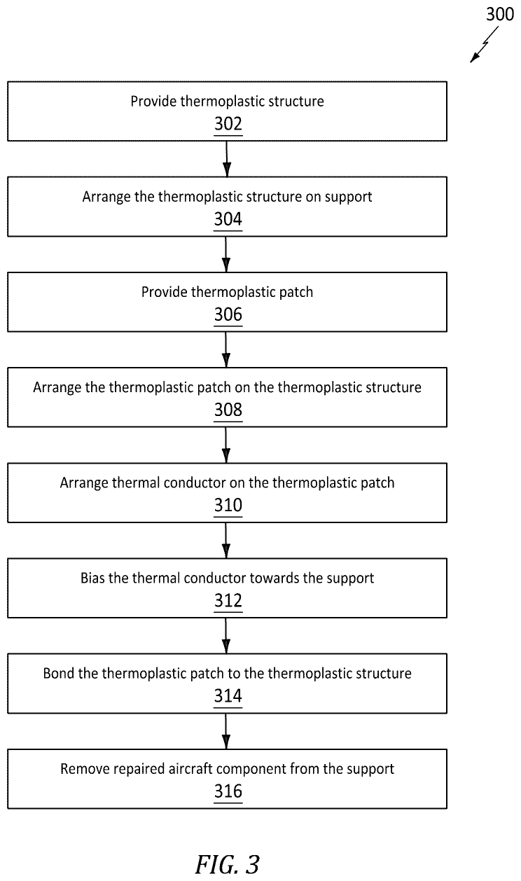

FIG. 3 is a flow diagram of a method 300 for remanufacturing, fixing and/or otherwise repairing a composite thermoplastic component. For ease of description, the repair method 300 is described below with respect to the repaired aircraft component 38 of FIG. 2. The repair method 300 of the present disclosure, however, may alternatively be used to repair various other types and/or structural configurations of aircraft components.

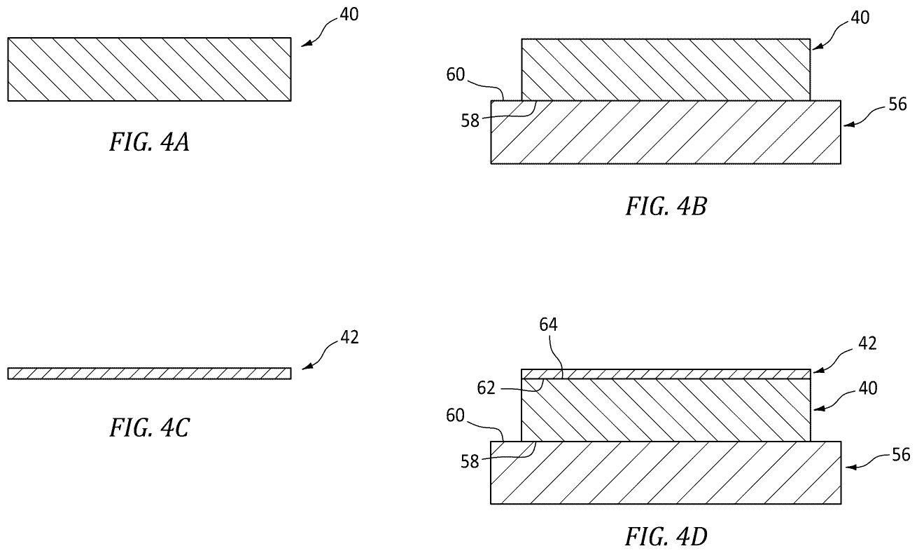

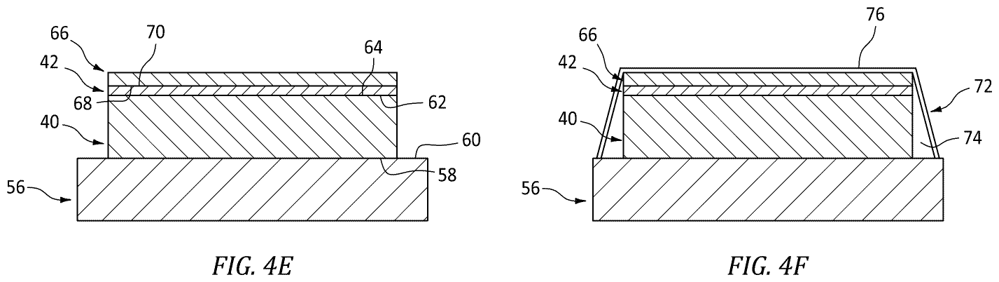

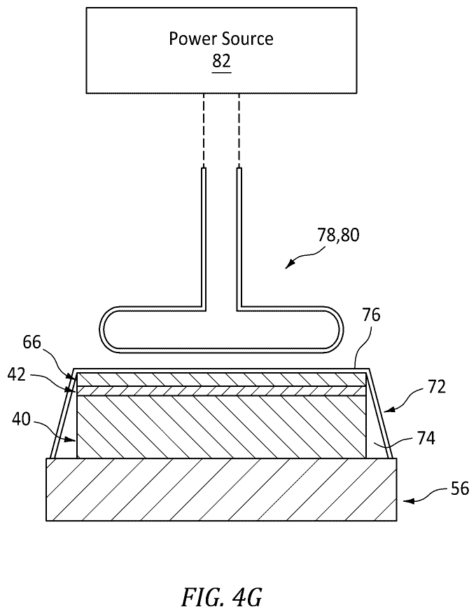

In step 302, referring to FIG. 4A, the thermoplastic structure 40 is provided. The thermoplastic structure 40, for example, may be removed from the aircraft 20 for this repair method 300. Alternatively, it is contemplated the repair method may alternatively be performed on-wing. The thermoplastic structure 40, for example, may remain installed with the aircraft 20 (or installed with a respective module of the aircraft 20).

In step 304, referring to FIG. 4B, the thermoplastic structure 40 may be arranged on a support 56. The thermoplastic structure 40 of FIG. 4B, for example, is disposed on top of the support 56 with a bottom side 58 of the thermoplastic structure 40 vertically engaging (e.g., contacting) a top surface 60 of the support 56. Herein, the terms “top” and “bottom” may describe relative vertical positions of an element during the illustrated repair method 300. However, it is contemplated the element may be alternatively oriented when assembled with the aircraft 20. Moreover, it is contemplated the element may be alternatively oriented during alternative embodiments of the repair method 300. Referring again to FIG. 4B, the support 56 may be configured as or otherwise include a die, an anvil, a mandrel, a table or other tooling. Of course, where the thermoplastic structure 40 is capable of being self-supported during the repair method 300, this step 304 may be omitted facilitating repair while the thermoplastic structure 40 remains installed with the aircraft 20, for example.

In step 306, referring to FIG. 4C, the thermoplastic patch 42 is provided. At this step, the thermoplastic patch 42 is discretely formed from and is not yet arranged with or bonded to the thermoplastic structure 40. The thermoplastic patch 42, however, may be tailored to fit with and/or have a specific geometry of an area on the thermoplastic structure 40 being repaired. Thus, the thermoplastic patch 42 may be pre-consolidated and tailored for a specific repair.

In step 308, referring to FIG. 4D, the thermoplastic patch 42 is arranged on the thermoplastic structure 40. The thermoplastic patch 42 of FIG. 4D, for example, is disposed on top of the thermoplastic structure 40 with a bottom surface 62 of the thermoplastic patch 42 vertically engaging (e.g., contacting) a top surface 64 of the thermoplastic structure 40. The thermoplastic patch 42 of FIG. 4D, in particular, overlays and fully engages the thermoplastic structure 40 and its top surface 64. At least a portion or an entirety of this thermoplastic patch 42 may have the same contour of the top surface 64 of the thermoplastic structure 40. With this arrangement, the thermoplastic structure 40 is disposed vertically between and may completely separate the support 56 and the thermoplastic patch 42.

In step 310, referring to FIG. 4E, a thermal conductor 66 is arranged on the thermoplastic patch 42. The thermal conductor 66 of FIG. 4E, for example, is disposed on top of the thermoplastic patch 42 with a bottom surface 68 of the thermal conductor 66 vertically engaging (e.g., contacting) a top surface 70 of the thermoplastic patch 42. The thermal conductor 66 of FIG. 4E, in particular, overlays and fully engages the thermoplastic patch 42 and its top surface 70. The thermal conductor 66 may be configured as a metal plate. This thermal conductor 66 and its bottom surface 68 may be contoured to a contour of the aircraft component to be repaired; e.g., a contour of the thermoplastic patch 42 and its top surface 70. With this arrangement, the thermoplastic patch 42 is disposed vertically between and may completely separate the thermoplastic structure 40 and the thermal conductor 66.

In step 312, referring to FIG. 4F, the thermal conductor 66 is biased vertically towards the support 56 and the thermoplastic structure 40. A stack of the elements 40, 42 and 66, for example, may be vacuum bagged together and against the support 56. The thermoplastic patch 42 may thereby be preloaded (e.g., sandwiched and compressed) vertically between the thermoplastic structure 40 and the thermal conductor 66 using a vacuum bag 72, where the stack elements 40, 42 and 66 are arranged within a vacuum bag cavity 74 between a wall 76 of the vacuum bag 72 and the support 56.

In step 314, referring to FIG. 4G, the thermoplastic patch 42 is bonded to the thermoplastic structure 40. The thermal conductor 66 of FIG. 4G, for example, may be heated using a heating device 78. This heating device 78 may be arranged vertically proximate the thermal conductor 66, where the thermal conductor 66 is disposed vertically between the heating device 78 and the thermoplastic patch 42. Here, the vacuum bag wall 76 is disposed vertically between the heating device 78 and the thermal conductor 66, and the heating device 78 may be vertically spaced from the vacuum bag wall 76 by a gap; e.g., an air gap, an empty volume, etc.

The heating device 78 of FIG. 4G is configured as an induction coil 80. During the bonding step 314, a power source 82 applies a high frequency (e.g., alternating) current to the induction coil 80. The induction coil 80 generates electromagnetic waves. These electromagnetic waves interact with (e.g., excite molecules of) material of the thermal conductor 66 thereby heating up the thermal conductor 66. This heated thermal conductor 66 conductively heats the thermoplastic patch 42 and its thermoplastic material. The heated thermal conductor 66 also conductively heats a portion of the thermoplastic structure 40 and its thermoplastic material next to the thermoplastic patch 42. Here, (a) the thermoplastic material of the heated thermoplastic patch 42 and (b) the thermoplastic material in the portion of the heated thermoplastic structure 40 adjacent the heated thermoplastic patch 42 may be heated enough to melt that thermoplastic material for bonding the thermoplastic patch 42 to the thermoplastic structure 40. The thermoplastic material, for example, may be heated enough such that the thermoplastic material of the thermoplastic patch 42 and the thermoplastic structure 40 softens, but not enough so as to liquify the thermoplastic material of the thermoplastic patch 42 and the thermoplastic structure 40. By melting the thermoplastic material of the thermoplastic patch 42 and the thermoplastic structure 40 while the thermoplastic patch 42 is preloaded against the thermoplastic structure 40 for a certain period of time and then (actively or passively) cooling the thermoplastic patch 42 and the thermoplastic structure 40 to solidify the thermoplastic material, the thermoplastic patch 42 is bonded to the thermoplastic structure 40 to form is unitary body. This unitary body may be the repaired aircraft component 38.

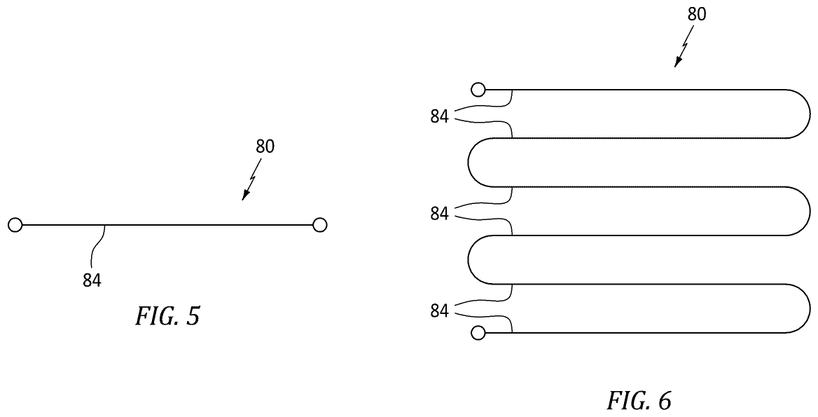

In some embodiments, referring to FIG. 5, the induction coil 80 may be configured as a linear induction coil. The induction coil 80 of FIG. 5, for example, includes a single (e.g., straight) elongated coil section 84 which moves along (e.g., translates/scans over) the thermal conductor during the bonding step 314. In other embodiments, referring to FIG. 6, the induction coil 80 may be configured as a planar induction coil. The induction coil 80 of FIG. 6, for example, includes multiple (e.g., straight, parallel) elongated coil sections 84 which collectively move along the thermal conductor during the bonding step 314. The present disclosure, however, is not limited to such exemplary induction coil types or configurations.

In step 316, the repaired aircraft component 38 is removed from the support 56. The vacuum bag 72, for example, may be removed. The repaired aircraft component 38 may then be lifted off of the support 56.

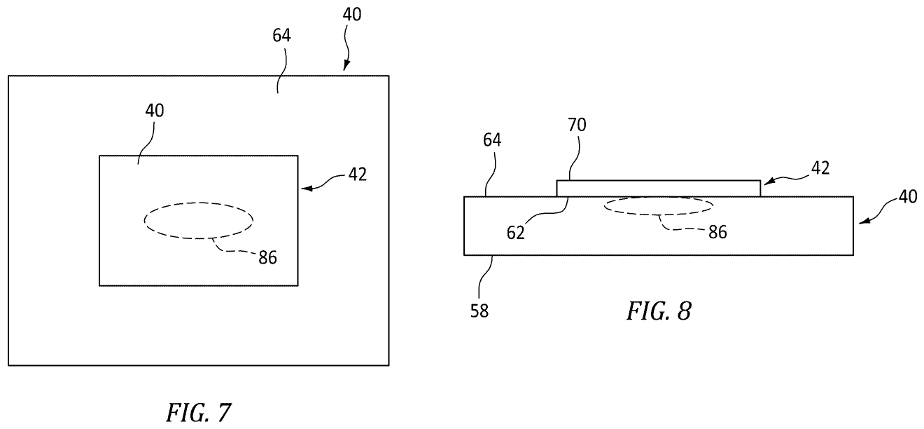

In some embodiments, referring to FIGS. 7 and 8, the thermoplastic patch 42 may be bonded to a damaged aircraft component to repair that aircraft component. The thermoplastic structure 40 of FIGS. 7 and 8, for example, includes a damaged area 86. Examples of this damaged area 86 include, but are not limited to: an area with a worn surface; an area with at least one deep scratch, an abrasion, a cut, a crack and/or an area with delamination; an area with an out of specification (e.g., high) porosity; an area with an out of specification (e.g., too small) dimension; an area with an enlarged fastener aperture; and/or the like. While the top surface 64 of the thermoplastic structure 40 may be cleaned or otherwise prepared for the bonding, the damaged area 86 is substantially left in the thermoplastic structure 40. Here, the thermoplastic patch 42 is arranged over and laterally covers a portion or an entirety of the damaged area 86. The thermoplastic patch 42 may also project away from the damaged area 86 and thereby also laterally cover a non-damaged area adjacent the damaged area 86; e.g., surrounding the damaged area 86. In such embodiments, the damaged area 86 may be substantially encapsulated by the thermoplastic patch 42 in the repaired aircraft component 38.

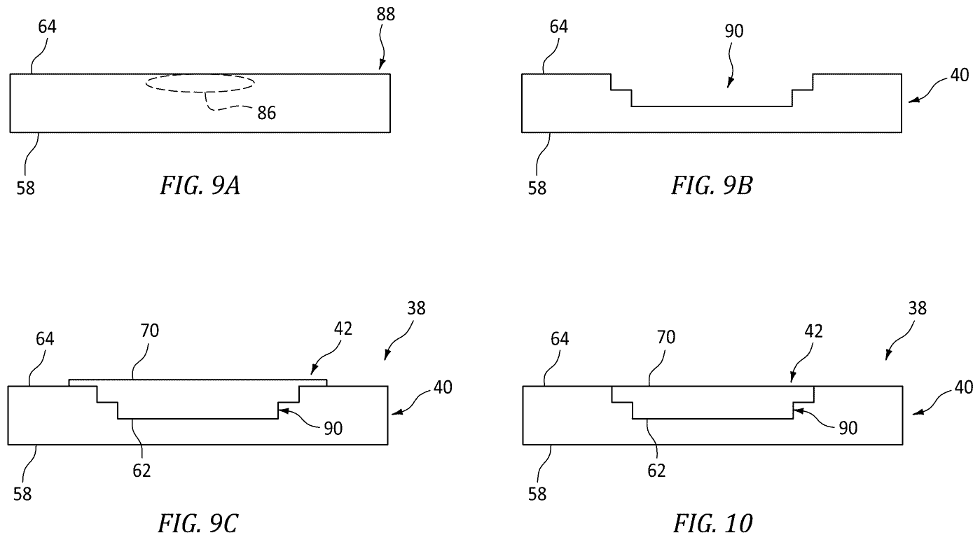

In other embodiments, the damaged area 86 may be partially or completely removed from the damaged aircraft component to provide the thermoplastic structure 40 for the bonding. For example, referring to FIG. 9A, a damaged aircraft component 88 may be received. This damaged aircraft component 88 includes the damaged area 86 which may extend along the top surface 64, project partially vertically into the damaged aircraft component 88 from the top surface 64, or project vertically through the damaged aircraft component 88. For ease of description, the damaged area 86 is described below as projecting partially vertically into the damaged aircraft component 88. Referring to FIG. 9B, the damaged area 86 may be partially or completely removed from the damaged aircraft component 88 to leave an aperture 90 in the thermoplastic structure 40. Referring to FIG. 9C, the thermoplastic patch 42 is disposed in the aperture 90. This thermoplastic patch 42 may partially for completely fill the aperture 90 and the thermoplastic patch 42 may then be bonded to the surrounding material of the thermoplastic structure 40 to provide the repaired aircraft component 38. While a portion of the thermoplastic patch 42 of FIG. 9C is disposed outside of the aperture 90 and overlaps a portion of the top surface 64 of the thermoplastic structure 40, the present disclosure is not limited thereto. For example, referring to FIG. 10, the top surface 70 of the thermoplastic patch 42 may alternatively be arranged vertically flush with the top surface 64 of the thermoplastic structure 40.

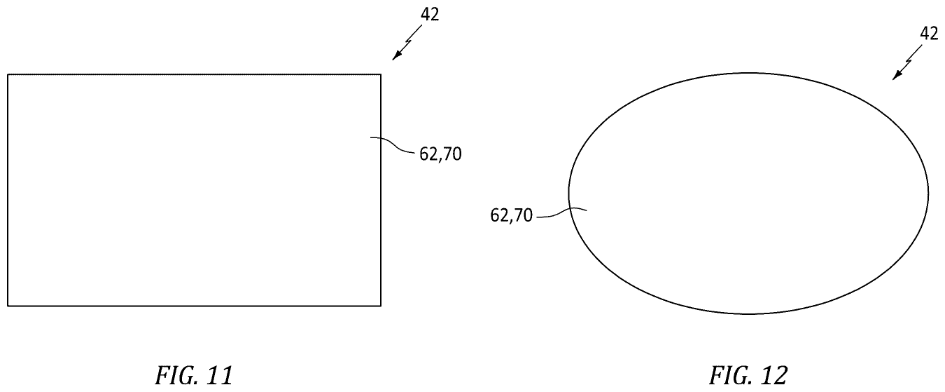

Referring to FIGS. 11 and 12, the thermoplastic patch 42 has an outer peripheral geometry when viewed, for example, in a reference plane parallel with one or both surfaces 62, 70 of the thermoplastic patch 42. In some embodiments, referring to FIG. 11, at least a portion or an entirety of the peripheral geometry may be polygonal. In other embodiments, referring to FIG. 12, at least a portion or an entirety of the peripheral geometry may be curved; e.g., circular, oval, etc.

While various embodiments of the present invention have been disclosed, it will be apparent to those of ordinary skill in the art that many more embodiments and implementations are possible within the scope of the invention. For example, the present invention as described herein includes several aspects and embodiments that include particular features. Although these features may be described individually, it is within the scope of the present invention that some or all of these features may be combined with any one of the aspects and remain within the scope of the invention. Accordingly, the present invention is not to be restricted except in light of the attached claims and their equivalents.

What is claimed is:

1. A repair method, comprising:
arranging a thermoplastic structure on a support;
arranging a thermoplastic patch on the thermoplastic structure;
arranging a conductor on the thermoplastic patch with the thermoplastic patch between the conductor and the thermoplastic structure;
heating the conductor using an induction coil to provide a heated conductor; and
heating the thermoplastic patch using the heated conductor to bond the thermoplastic patch to the thermoplastic structure.

2. The repair method of claim 1, wherein the thermoplastic structure includes thermoplastic material and fiber-reinforcement embedded within the thermoplastic material.

3. The repair method of claim 1, wherein the thermoplastic patch includes thermoplastic material and fiber-reinforcement embedded within the thermoplastic material.

4. The repair method of claim 3, wherein
the thermoplastic structure includes second thermoplastic material and second fiber-reinforcement embedded within the second thermoplastic material; and
the thermoplastic material and the second thermoplastic material are a common thermoplastic material.

5. The repair method of claim 1, wherein the thermoplastic patch is a pre-consolidated thermoplastic patch.

6. The repair method of claim 1, wherein at least one of
the thermoplastic patch contacts the thermoplastic structure; or
the thermoplastic patch contacts the conductor.

7. The repair method of claim 1, wherein the conductor comprises a metal plate.

8. The repair method of claim 1, wherein the thermoplastic patch is bonded to the thermoplastic structure to provide a repaired thermoplastic structure, and further comprising removing the conductor from the repaired thermoplastic structure.

9. The repair method of claim 1, wherein the induction coil comprises a linear induction coil.

10. The repair method of claim 1, wherein the induction coil comprises a planar induction coil.

11. The repair method of claim 1, further comprising biasing the conductor towards the support to press the thermoplastic patch between the conductor and the thermoplastic structure.

12. The repair method of claim 11, wherein the conductor is biased towards the support using a vacuum bag.

13. The repair method of claim 1, wherein
the thermoplastic structure comprises a damaged area;
the thermoplastic patch covers the damaged area; and
the thermoplastic patch is bonded to the thermoplastic structure to provide a repaired thermoplastic structure.

14. The repair method of claim 1, further comprising:
removing a damaged area from a damaged thermoplastic structure to provide the thermoplastic structure, the thermoplastic structure including an aperture formed during the removing of the damaged area;
wherein the thermoplastic patch arranged on the thermoplastic structure is disposed in and at least partially fills the aperture.

15. The repair method of claim 1, wherein at least a portion of a peripheral geometry of the thermoplastic patch is polygonal.

16. The repair method of claim 1, wherein at least a portion of a peripheral geometry of the thermoplastic patch is curved.

17. A repair method, comprising:
arranging a thermoplastic patch on a thermoplastic structure, the thermoplastic structure comprising a damaged area, and the thermoplastic patch covering the damaged area;
arranging a metal conductor on the thermoplastic patch with the thermoplastic patch between the metal conductor and the thermoplastic structure;
heating the metal conductor using a heating element to provide a heated conductor;
heating the thermoplastic patch using the heated conductor to bond the thermoplastic patch to the thermoplastic structure and provide a repaired thermoplastic structure; and
removing the metal conductor from the repaired thermoplastic structure.

18. The repair method of claim 17, wherein the damaged area is encapsulated by the thermoplastic patch in the repaired thermoplastic structure.

19. The repair method of claim 17, further comprising biasing the metal conductor towards the thermoplastic patch.

20. A repair method, comprising:
removing a damaged area from a damaged thermoplastic structure to provide a thermoplastic structure with an aperture, the aperture projecting into the thermoplastic structure from an exterior surface of the thermoplastic structure;
arranging a thermoplastic patch on the thermoplastic structure with the thermoplastic patch at least partially filling the aperture;
arranging a metal conductor on the thermoplastic patch with the thermoplastic patch between the metal conductor and the thermoplastic structure;
heating the metal conductor using a heating element to provide a heated conductor;
heating the thermoplastic patch using the heated conductor to bond the thermoplastic patch to the thermoplastic structure and provide a repaired thermoplastic structure; and
removing the metal conductor from the repaired thermoplastic structure.
